(19) United States
(12) Patent Application Publication
(10) Pub. No.: US 2002/0123898 A1
(43) Pub. Date: Sep. 5, 2002

(54) System and method for managing business to business customer extranet

(76) Inventors: Marie-Helene Lemay, Southington, CT (US); Erik Molitor, Middletown, CT (US); Krishnamoorthy Balasubramaniam, Plainville, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,244

(22) Filed: Mar. 5, 2001

(51) Int. Cl. G06F 17/60

(52) U.S. Cl. 705/1

(57) ABSTRACT

A system and a method for managing various customer communities utilize a web-enabled interactive database to organize, store and retrieve the information for the benefit of the customer community to effectively manage the business. The system captures all customers related information and provides on-line up-to-date information to the users upon request. A directory structure managed by the server system helps organize the customer relevant information by pre-defined community names, segment names, module names, common segments, and common communities.

### COPYRIGHT STATEMENT

A portion of the disclosure of this patent document contains material that is to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

This invention relates generally to management of personalized Business to Business (B2B) web sites, and more particularly, to network-based systems and methods for creating password protected web containing tools and information for doing business with a corporate headquarters.

The Internet is used extensively in managing day to day business. The Internet also a source and a method of communication with the customers. There is a growing need for corporations to disseminate products as well as services information to customers in a timely fashion to meet aggressive revenue and profitability targets. When the information on a corporation“s products and is not centralized, it can potentially create confusion to the customers and often of the business. Customer confusion leads to a loss of loyalty and ultimate impact on market performance. For example, multiple avenues to enter an order for a product creates not only confusion but significant dissatisfaction of the customer. Similar problems exist when the customer seeks product related technical information, if the web site is not property organized. Lack of organization may force the customer to make multiple calls to resolve the problem or seek sources for the product or the services.

The problem is more acute in large organizations having multiple divisions, especially organizations with globally distributed divisions where managing what customer wants requires immediate attention and review across the globe. Additionally, even organizations which use web technology to streamline the are unable to manage this large amount of customer required information rapidly and efficiently because of their inability to organize and present the information in meaningful way to different users having different needs.

Therefore, it would be desirable to streamline the process and make electronically available the information necessary to customers to run their and help make them timely decisions with respect to corporation“s products and services. In addition, it would be desirable to implement systems and processes will manage the extranet that facilitates dissipation of the information to multiple customers located at different locations expeditiously to improve efficiency.

### SUMMARY OF INVENTION

A Customers Communities System (CCS), in one embodiment, includes a web-enabled interactive database to manage customers communities on-line. The CCS captures a customer“s relevant information and provides on-line, up-to-date information upon request. The CCS tracks a customer“s relevant information from inception to completion and provides a status to users in response to their In the exemplary embodiment, the system utilizes a hierarchical database with a client user interface front-end for administration and a web interface for standard user input and reports. Information is accessed in the database through Structured Query Language (SQL) and Light Weight Directory Access Protocol (LDAP) querries. The CCS includes a centralized interactive database for use in automating documentation, monitoring and tracking activities associated with management of various customer communities of a corporation.

In one embodiment of the invention, the CCS is a method for organizing communities of users having similar needs and interests using a web-based including a server system coupled to a centralized interactive database and at least one client system. The method includes the steps of defining various communities and users of various communities, identifying tools and information relating to various communities, setting up a number of pre-defined modules for each community, and providing users access to a specific community and associated modules of the specific community based on enrollment criteria to obtain information stored in a centralized database in response to an inquiry.

The CCS supports various levels of management hierarchy and provides access to individuals based on the position held by the individual within the business In another embodiment, the CCS is a system configured to manage the process to organize various customer communities.

In yet another embodiment, the invention is a computer program embodied on computer readable medium for managing various customer communities for a corporation. The program includes a code segment that sets up a directory to organize information into a centralized database and provides users access to a specific community and associated modules of the specific community based on enrollment criteria to obtain information stored in the centralized database in response to an inquiry.

### BRIEF DESCRIPTION OF DRAWINGS

FIG. 1 is a simplified block diagram of a Customers Communities System in accordance with one embodiment of the present invention.

FIG. 2 is an expanded version block diagram of an exemplary embodiment of a server architecture of the CCS.

FIG. 3 shows a configuration of a database within the database server of the server system with other related server components.

FIG. 4 depicts various communities that are organized under the CCS by the corporation.

FIG. 5 is an exemplary embodiment identifying Tools and Information pertinent for Distributor Communities.

FIG. 6 is an exemplary embodiment of a Location Administrator Enrollment Form to be completed by a location administrator.

FIG. 7 is an exemplary embodiment of a User Enrollment Form to be completed by a location administrator for each of their approved locations.

FIG. 8 is an exemplary embodiment of a community home page generated by the CCS.

FIG. 9 is an exemplary embodiment of a Directory Structure depicting the various communities are organized.

FIG. 10 is an exemplary embodiment of a Directory Structure depicting the way OEM Communities are organized.

FIG. 11 is an exemplary embodiment of a home page user interface of the distributor communities shown in FIG. 4.

FIG. 12 is another exemplary embodiment of a home page user interface of the distributor communities shown in FIG. 4.

FIG. 13 is an exemplary embodiment of a Policies user interface downloaded and displayed by the server system when the user selects Policies hypertext link (shown in FIG. 12).

FIG. 14 is an exemplary embodiment of a Speedi Tool Updates user interface downloaded and displayed by the server system when the user selects Speedi Tool Updates hypertext link (shown in FIG. 12).

FIG. 15 is an exemplary embodiment of EliteNet Advantages user interface downloaded and displayed by the server system when the user selects EliteNet Advantage hypertext link (shown in FIG. 12).

FIG. 16 is an exemplary embodiment of a Business Advisor user interface downloaded and displayed by the server system when the user selects Business Advisor hypertext link (shown in FIG. 12).

FIG. 17 is an exemplary embodiment of a Pronto Pricing Tool user interface downloaded and displayed by the server system when the user selects Pronto Tool hypertext link (shown in FIG. 12).

FIG. 18 is an exemplary embodiment of a Training user interface and displayed by the server system when the user selects Training hypertext link (shown in FIG. 12).

FIG. 19 is an exemplary embodiment of a Library user interface downloaded and displayed by the server system when the user selects Library hypertext link (shown in FIG. 12).

FIG. 20 is an exemplary embodiment of an Industry Links user interface downloaded and displayed by the server system when the user selects Industry hypertext link (shown in FIG. 12).

FIG. 21 is an exemplary embodiment of a Product Information user interface downloaded and displayed by the server system when the user selects Product Information hypertext link (shown in FIG. 12).

FIG. 22 is an exemplary embodiment of a Technical Information user downloaded and displayed by the server system when the user selects Technical Information hypertext link (shown in FIG. 12).

FIG. 23 is an exemplary embodiment of a Motor Search user interface downloaded and displayed by the server system when the user selects Motor hypertext link (shown in FIG. 12).

FIG. 24 is an exemplary embodiment of a Commercial Project Advisor user interface downloaded and displayed by the server system when the user selects Commercial Project Advisor hypertext link (shown in FIG. 12).

FIG. 25 is an exemplary embodiment of a Solutions Advisor List user downloaded and displayed by the server system when the user selects Solutions Advisor List hypertext link (shown in FIG. 12).

FIG. 26 is an exemplary embodiment of a Track Your Order user interface downloaded and displayed by the server system when the user selects Track Your Order 366 hypertext link (shown in FIG. 12).

FIG. 27 is an exemplary embodiment of a Price & Availability Lookup user interface downloaded and displayed by the server system when the user selects & Availability Lookup hypertext link (shown in FIG. 12).

FIG. 28 is an exemplary embodiment of a Current Order user interface downloaded and displayed by the server system for obtaining the information on current open orders.

FIG. 29 is an exemplary embodiment of a Billing & Shipping Information user interface downloaded and displayed by the server system to facilitate the obtaining the billing and shipping information on open orders.

FIG. 30 is an exemplary embodiment of an Availability user interface downloaded and displayed by the server system to facilitate obtaining the product availability information based on a model number or a stock number.

FIG. 31 is an exemplary embodiment of a flow chart describing the method organizing communities of users having similar needs and interests.

### DETAILED DESCRIPTION

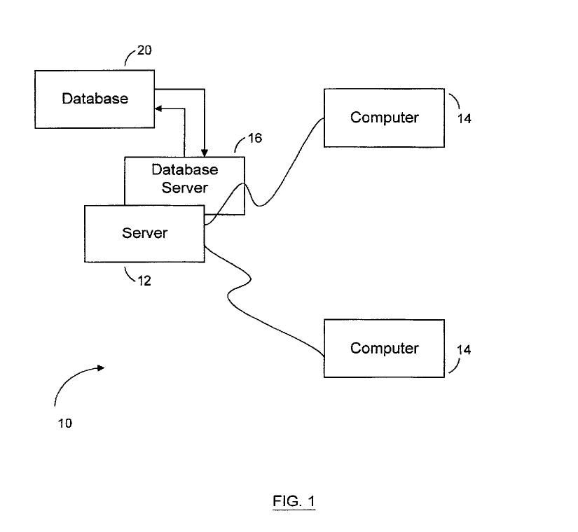

FIG. 1 is a simplified block diagram of a Customers Community System (CCS) 10 including a web/application server system 12 and a plurality of client systems connected to server system 12. CCS 10 provides a system and a methodology to group customers in communities of users having similar needs and interests. For example, in one exemplary embodiment, the customers can be grouped into five different categories: Distributor Communities, Original Equipment Manufacturers (OEM) Communities, Utility Communities, Industrial Communities, and Contractor Communities. If necessary, one customer can be part of more than one community. Tools and information pertinent for this customer community is identified and set up as modules which are accessed by each customers within that community. and confidential information of one customer within a community cannot be accessed by another customer within that community. Each community has a set number of modules. Members of a community have access to the same set of module unless more than one role is identified within a community. Example, for a community A, roles such as Manager, Sales Representative, Purchasing Agent etc., can be defined. In this case, a Manager can have one set of modules and a Sales Representative can have a different set of modules. Role definition is not necessary within a community.

CCS 10 manages all defined communities of a corporation. For example, CCS manages Distributor Communities, Original Equipment Manufacturers (OEM) Communities, Utility Communities, Industrial Communities, and Contractor Communities.

In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone or other web-based connectable equipment. A database server 16 is connected to a centralized database 20. In an exemplary embodiment, database server 16 includes an Oracle database and an LDAP database. Database 20 are basically multiple different database applications. In yet another embodiment, database 20 contains product related information on a variety of products. In one embodiment, centralized database 20 is stored on database server 16 and can be accessed by potential users at one of client systems 14 by logging onto server system 12 through one of client systems 14. In an alternative embodiment centralized database 20 is stored remotely from server system 12.

The CCS utilizes a web-enabled interactive database to automate information and management process. System 10 captures all communities related information and provides on-line, up-to-date information upon request. In one exemplary embodiment, system 10 utilizes a Relational Database with a client user interface front-end for administration and a web interface for standard user input and reports. Information is accessed in the database through Structured Query (SQL). CCS 10 is an information and management tool that can be used effectively build stronger relationship with the customer base.

System 10 supports various levels of management hierarchy and provides to individuals based on the position held by the individual within the corporation.

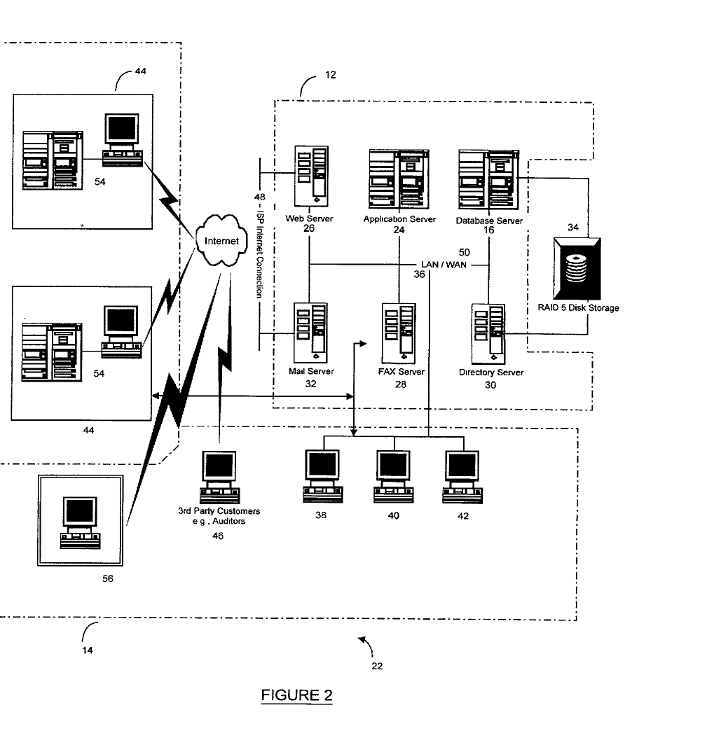

FIG. 2 is an expanded version block diagram of an exemplary embodiment of a server architecture of a CCS 22. CCS 22 is utilized when the communities are numerous and require a stronger and more powerful system architecture. Components in system 22, identical to components of system 10 (shown in FIG. 1), are identified in FIG. 2 using the same reference numerals used in FIG. 1. System 22 includes server system 12 and client systems 14. Server system 12 further includes a database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator“s workstation 38, a user workstation 40, and a supervisor“s workstation 42 are coupled to LAN 36. Alternatively, workstations 38, 40, and 42 coupled to LAN 36 via an Internet link or are connected through an intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 40, and 42 are illustrated as being associated with separate functions only to facilitate an understanding of the different types of functions that can be by individuals having access to LAN 36.

In another embodiment, server system 12 is configured to be communicatively coupled to various individuals or employees 44 and to third parties, e.g., internal external auditors, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced the Internet. In addition, and rather than WAN 50, local area network 36 could be used in place of WAN 50.

In the exemplary embodiment, any authorized individual or an employee of the corporation having a workstation 54 can access CCS 22. One of the client systems includes a senior manager“s workstation 56 located at a remote location. Workstations 54 and 56 are personal computers having a web browser. Also, workstations 54 and 56 are configured to communicate with server system 12. Furthermore, fax server 28 communicates with employees located outside the business entity“s 44 and any of the remotely located client systems, including a client system 56 via a telephone link. Fax server 28 is configured to communicate with other client systems 38, 40, and 42 as well.

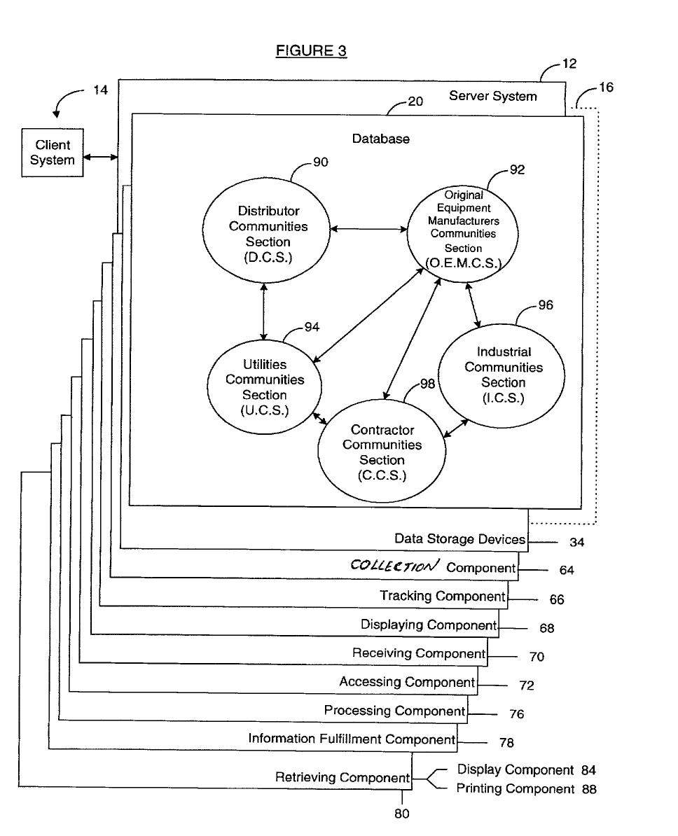

FIG. 3 shows a configuration of database 20 within database server 16 of server system 12 shown in FIG. 1. Database 20 is coupled to several separate components within server system 12, which perform specific tasks.

Server system 12 includes a collection component 64 for collecting information from users into centralized database 20, a tracking component 66 for tracking information, a displaying component 68 to display information, a receiving component 70 to receive a specific query from client system 14, and an accessing component 72 to access centralized database 20. Receiving component 70 is programmed for receiving a specific query from one of a plurality of users. Server system 12 further includes a processing component 76 for searching and received queries against data storage device 34 containing a variety of information collected by collection component 64. An information fulfillment component 78, located in server system 12, downloads the requested information to the plurality users in the order in which the requests were received by receiving component 70. Information fulfillment component 78 downloads the information after the information is retrieved from data storage device 34 by a retrieving component 80. Retrieving component 80 retrieves, downloads and sends information to client system 14 based on a query received from client system 14 regarding various alternatives.

Retrieving component 80 further includes a display component 84 configured download information to be displayed on a client system“s graphical user interface and a printing component 88 configured to print information. Retrieving 80 generates various reports requested by the user through client system 14 in a pre-determined format. System 10 is flexible to provide alternative reports and is not constrained to the options set forth above.

Database 20 is divided into a Distributor Communities Section (DCS) 90, Equipment Manufacturers (OEM) Communities Section (OEMCS) 92, Utility Communities Section (UCS) 94, Industrial Communities Section (ICS) 96, and Contractor Communities Section (CCS) 98. Sections 90, 92, 94, 96 and 98 within database 20 are interconnected to update and retrieve the information as required. Each Community Section is further divided into several individualized sub-sections to store data in various different categories.

The architecture of system 10 as well as various components of system 10 are exemplary only. Other architectures are possible and can be utilized in connection with practicing the processes described below.

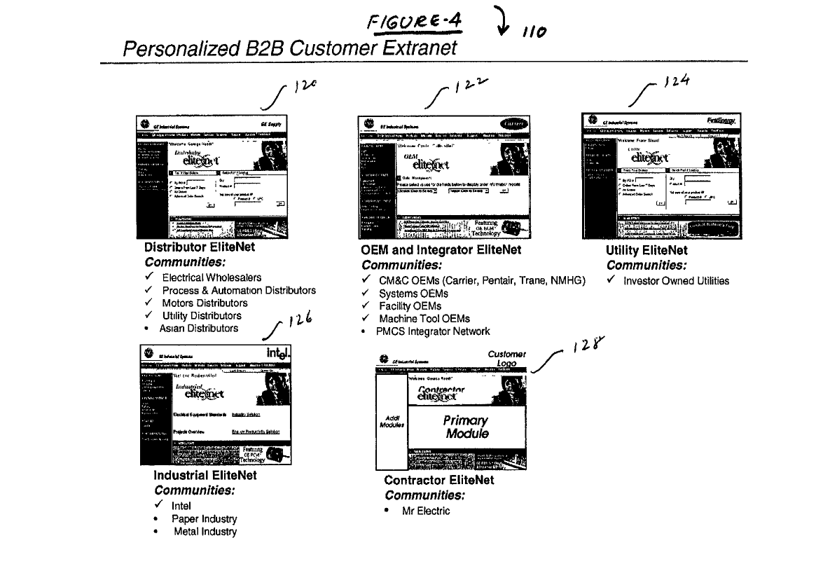

FIG. 4 depicts various communities 110 that are organized under CCS 10 by the corporation. CCS 10 manages all defined communities of a corporation. CCS 10 provides a system and a methodology to group customers in communities of users having similar needs and interests examples of those communities are shown. In embodiment, one customer can not be part of more than one community. In embodiment of the invention, one customer can be part of more than one community. For example, as shown in FIG. 4, CCS 10 manages Distributor Communities 120, Original Equipment Manufacturers (OEM) Communities 122, Utility Communities 124, Industrial Communities 126, and Contractor 128. Distributor Communities 120 include Electrical Wholesalers, Process and Automation Distributors, Motor Distributors, Utility Distributors and Asian Distributors. Original Equipment Manufacturers (OEM) Communities 122 include & C OEMs, Systems OEMs, Facility OEMs, Machine tool OEMs, and PMCS Integrator Network. Utility Communities 124 include Investor Owned Utilities. Industrial Communities 126 include Intel, Paper Industry, and Metal Industry. Contractor Communities 128 include various contractor communities including Mr. Electric. These examples are exemplary only and there are many variations possible.

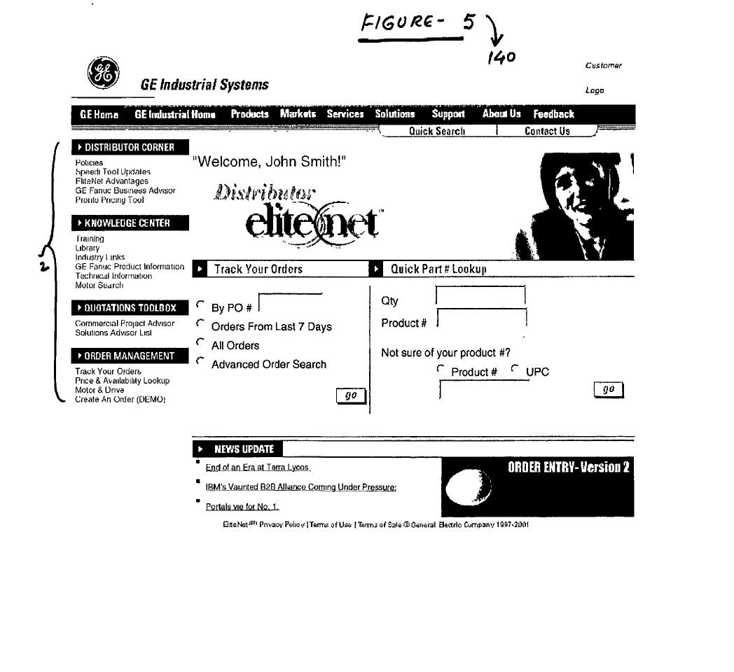

FIG. 5 is an exemplary embodiment 140 identifying Tools and Information pertinent for Distributor Communities 120. Tools and Information pertaining to distributor community is identified and set up as modules 142. Each community a set number of modules. For example, Distributor Communities 120 (shown in FIG. 4) has four separate modules: a Distributor Corner Module, a Knowledge Center Module, a Quotations Toolbox Module, and an Order Management Module. Members of a community have access to the same set of module unless more than one role is identified within a community. Example, for a community A, roles such Manager, Sales Representative, Purchasing Agent etc., can be defined. In this case, Manager can have one set of modules and Sales Representative can have a different set of module. Role definition is not necessary within a community.

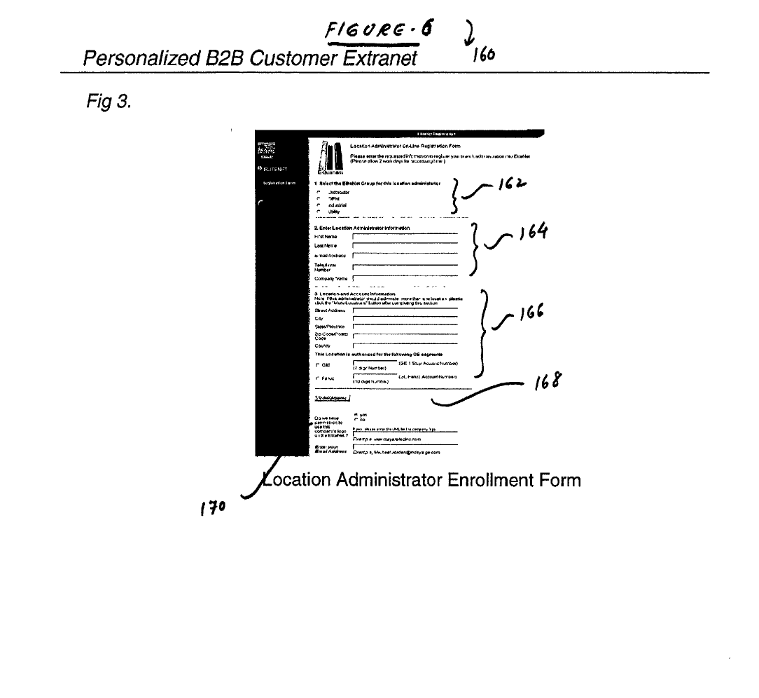

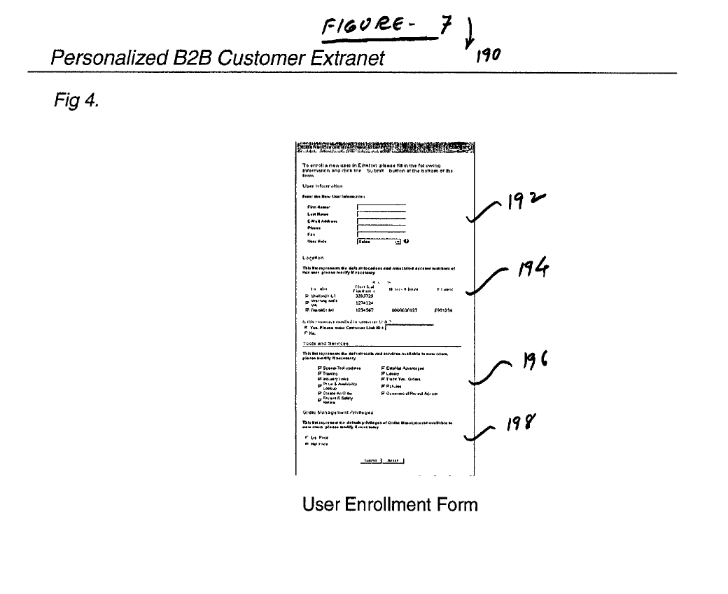

FIG. 6 and FIG. 7 describe the customer enrollment process that is completed through two separate steps. Upon completion of two steps of the customer enrollment process, each individual user is set up in customer database with defined community, role access and other related unique identifiers. During first step of the customer enrollment process, which includes completing a Administrator Enrollment Form (shown in FIG. 3, below), customer community module access is set up. During the second step of the customer enrollment process, which includes completing a User Enrollment Form (shown in FIG. 4, below), the authorized location administrator enrolls individuals for their approved location.

FIG. 6 is an exemplary embodiment of a Location Administrator Enrollment Form 160 to be completed by a location administrator or a corporation employee. The corporation enrolls one location administrator for each customer location. Location Administrator Enrollment Form 160 requires the identification of a community out of four possible options 162. The location Administrator is also requested to provide Location Administration Information 164, Location and Information 166, and Other Pertinent Details 168 including an authorization to use company logo 170 on the Distributor communities web site. Location Enrollment Form 160 is completed by a location administrator or a corporation employee and has the responsibility of enrolling and setting up the individual privileges for the other individuals at this customer location.

FIG. 7 is an exemplary embodiment of a User Enrollment Form 190 to be completed by a location administrator for each of their approved locations. form 190, the location administrator enrolls individuals and individual roles are assigned. Location administrator is given an additional module in personalized extranet allowing the location administrator to enroll new additional users. form 190, User Information 192 is solicited. User Information 192 also identifies User“s Role within the business. Form 190 also requests the administrator to default locations 194 of the user, Tools and Services 196 available to the user, and Default Privileges of Order Management 198. Once form 190 is completed, the administrator submits the form for processing.

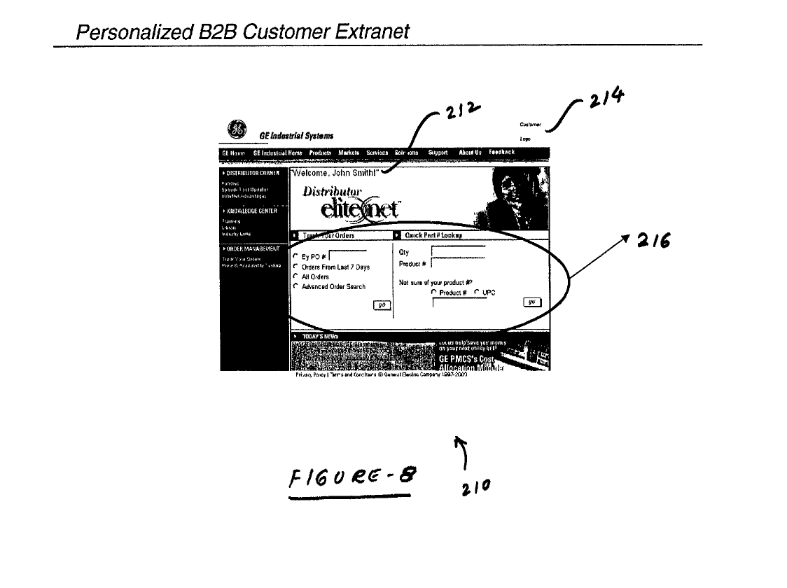

FIG. 8 is an exemplary embodiment of a home page 210 generated by CCS utilizing a program code—*.jsp. Java Server Pages, a server-side technology, are extension to the Java servlet technology that was developed by Sun as an to Microsoft's ASPs (Active Server Pages). JSPs have dynamic scripting capability works in tandem with HTML code, separating the page logic from the static—the actual design and display of the page. Embedded in the HTML page, the Java source code and its extensions help make the HTML more functional, being used in dynamic database queries, for example. JSPs are not restricted to any specific platform or server.

Home page 210 is the home page of Distributor Communities 120, shown in FIG. 4. Home page 210 is personalized to provide the modules specified for each user depending on their community and role. Home page 210 also allows personalization on the individual level by displaying their name 212 and company logo 214 on the home page. Note that the middle part of the home page is called a module of choice 216 intended to be the module most likely to be used by the individual. Module of choice 216 is personalized by community and role. Each module can be either a set of static page (.html) or an application.

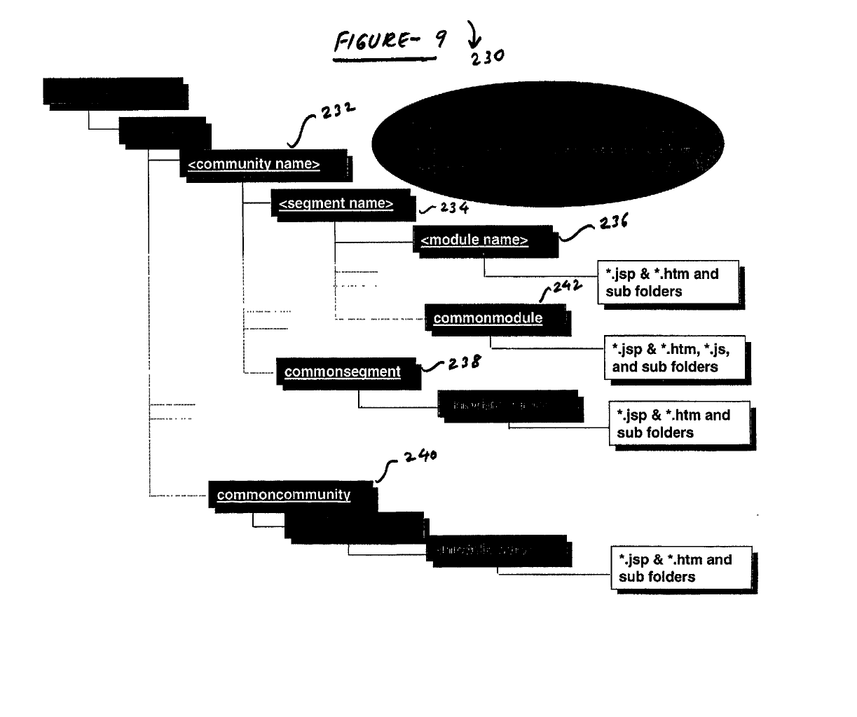

FIG. 9 is an exemplary embodiment of a Directory Structure 230 depicting way various communities are organized. Directory Structure 230 also provides a naming convention that provides consistency across various communities in organizing data. A community name 232 is the name of the community, a segment name 234 is the name of the segment under the community. And a module name 236 is the name of the module. The situation in which one module is being used more than one segment is placed under a common segment 238, while the used by more than one community is placed under a common community 240. If a file or a sub-folder is used by more than one module, it is placed under a common module 242.

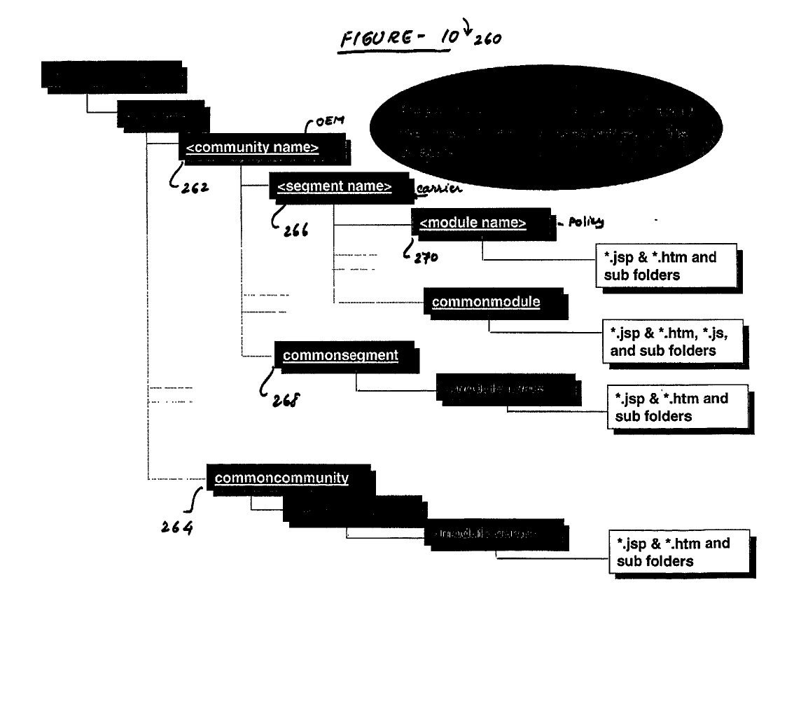

FIG. 10 is an exemplary embodiment of a Directory Structure 260 depicting the way OEM Communities 122 (shown in FIG. 4) are organized. Directory Structure 260 provides a naming convention that provides consistency across OEM Communities 122 in organizing data. The OEM is a primary directory 262 for the community. All the users with attribute community OEM are provided access to this primary directory. Modules used across different OEM communities are placed a common community 264. A segment name is the primary directory for the segment. For example, for segment carrier 266, the carrier will be the primary directory of the segment. The only users with the attribute segment carrier are permitted access to this segment. Modules used across different segments under a particular community are placed under a common segment 268. A module name 270 is the primary directory for the module. For example, for module Policy 270, policy will be the primary directory of the segment. The only users with one of the values of attribute module policy 270 are permitted access to this directory.

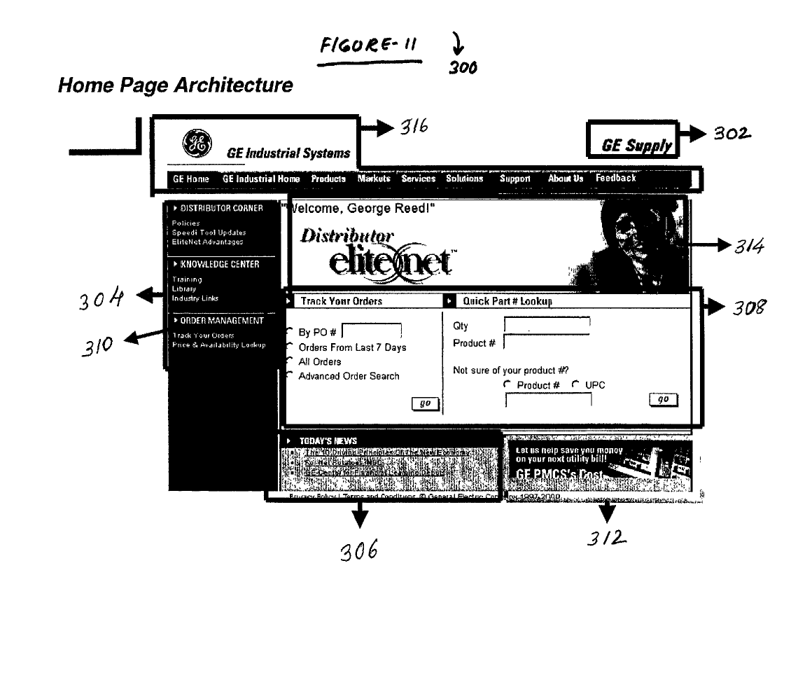

FIGS. 11 through 29 are exemplary embodiments of user interfaces utilized the organization of Distributor Communities 120, shown in FIG. 4. Through a series of user interfaces, the community user is provided various useful options. FIGS. 11 through 29 demonstrate the type of the information accumulated, stored and updated on a regular basis to support the Distributor Communities. The information contained in these user interfaces is exemplary only and changes from community to a community. The information provided through the user interfaces depicted in FIGS. 11 through 29 is stored in centralized database 20 and retrieved by server system 12 as required. Many variations of particular user interfaces or screens viewable by the user can be utilized. The following description refers to one set of screens that can be used to prompt the user to retrieve variety of information or to make the necessary inputs to enable system to generate various reports, charts, or status reports. Of course, many variations of such screens are possible.

Referring now specifically to the drawings, FIG. 11 is an exemplary embodiment of a home page user interface 300 of distributor communities 120 shown in FIG. 4. Home page 300 is organized into various different sections or areas. An area 302 contains a company logo in .gif format. An area 304 contains module navigational bar. Navigational bar is displayed on all user interfaces and is dynamically generated by the personalization of database 20. An area 306 contains the news section. The purpose of this is to provide users within a community with industry relevant news. Area 306 is defined at the segment level within the structure. An area 308 contains the preferred module. Area 308 is reserved to provide the user with quick and easy access to the modules the users are most to use. Area 308 is displayed based on the user roles (for example, Sales, Manager, etc.) and the segment of the user. Area 308 can be either a static HTML file or a servlet or a JSP. An area 310 contains the Navigation Section Headers. The purpose of this is to cluster similar modules and facilitate user navigation. These clusters fixed for all members of the segment and should be decided at the segment level. An area 312 contains a banner ad. Information for banner ads may vary from a community to a community. An area 314 displays an EliteNet Logo and a personalized welcome message. An area 316 contains static information that is common for all groups and generally not altered.

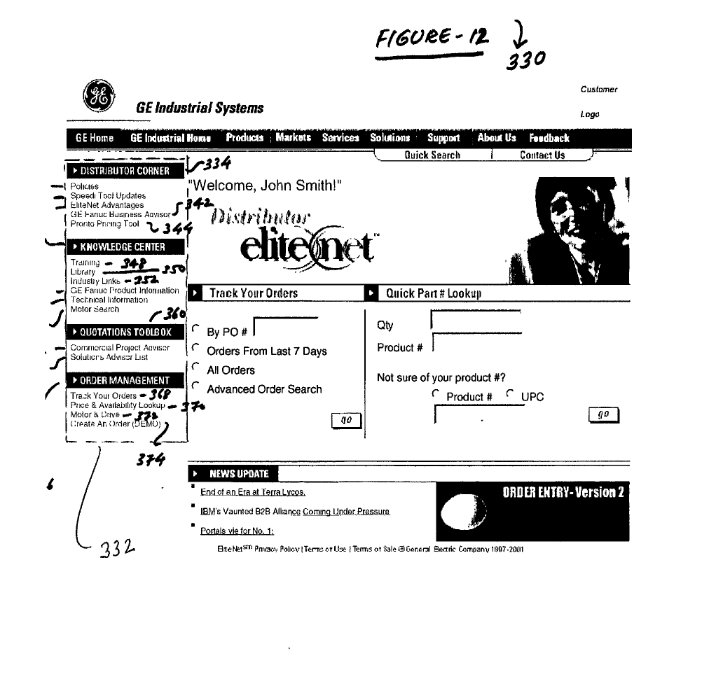

FIG. 12 is another exemplary embodiment of a home page user interface 330 of distributor communities 120 shown in FIG. 4. An area 332 (same as area 304, shown in FIG. 11) contains the module navigational bar and is displayed on all user interfaces of Distributor Communities web site. Area 332 is divided into four major Sections, each section further divided into separate sub-sections. For example, a Distributor Corner 334 section is further divided into Policies 336, Tool Updates 338, EliteNet Advantages 340, a Business Advisor 342, and a Pronto Pricing Tool 344. A Knowledge Center 346 section is divided into Training 348, Library 350, Industry Links 352, Product Information 354, Technical Information 356, and Motor Search 358. A Quotation Toolbox 360 section is divided into a Commercial Project Advisor 362, and a Solutions Advisor List 364. An Order Management 366 section is divided into Track Your Order 368, Price & Availability Lookup 370, Motor & Drive 372, and Create An Order 374.

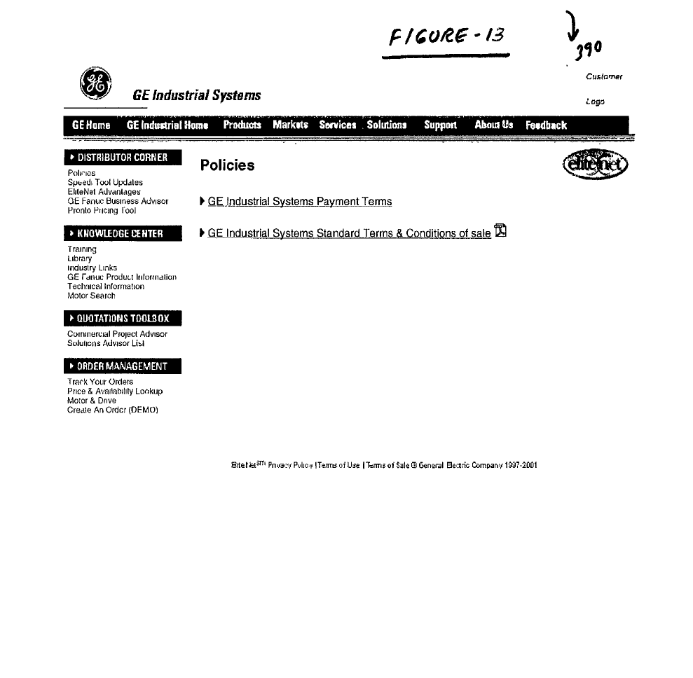

FIG. 13 is an exemplary embodiment of a Policies user interface 390 downloaded and displayed by server system 12 when the user selects Policies 336 hypertext link (shown in FIG. 12).

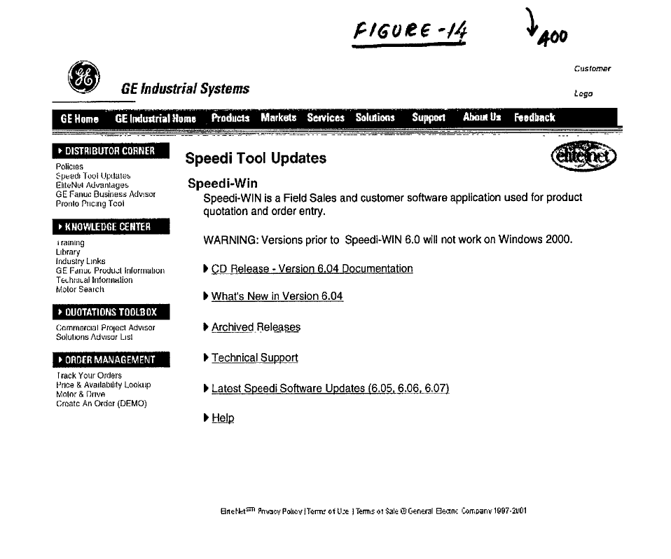

FIG. 14 is an exemplary embodiment of a Speedi Tool Updates user interface 400 downloaded and displayed by server system 12 when the user selects Speedi Tool Updates 338 hypertext link (shown in FIG. 12).

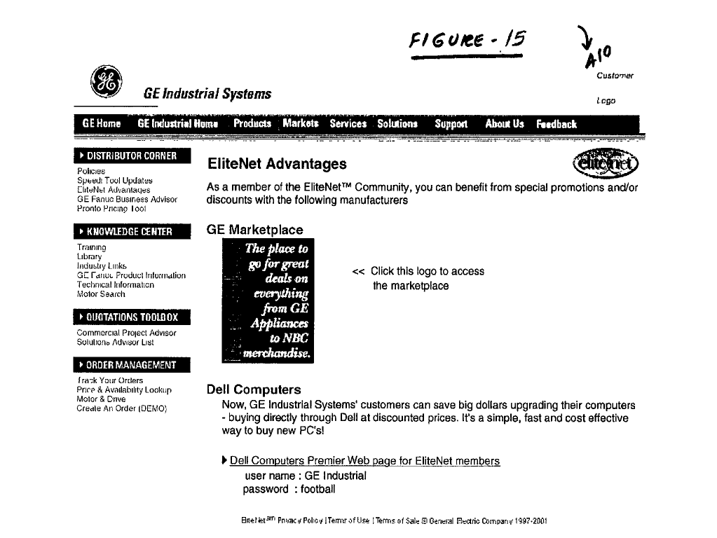

FIG. 15 is an exemplary embodiment of EliteNet Advantages user interface 410 downloaded and displayed by server system 12 when the user selects EliteNet Advantages 340 hypertext link (shown in FIG. 12).

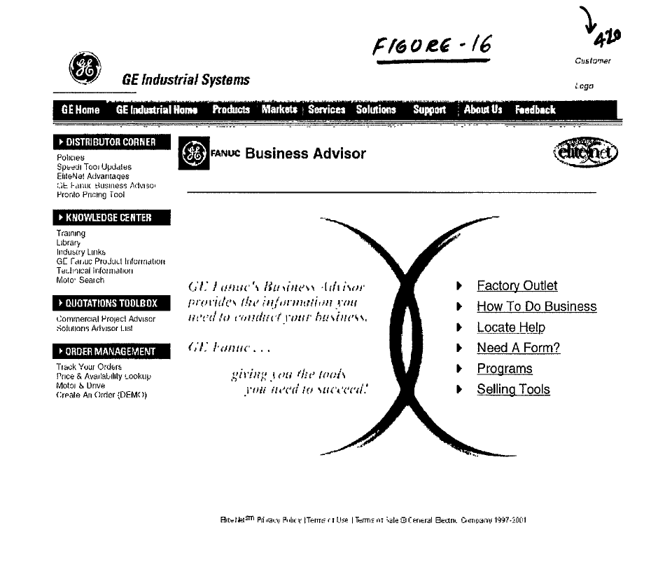

FIG. 16 is an exemplary embodiment of a Business Advisor user interface downloaded and displayed by server system 12 when the user selects Business Advisor 342 hypertext link (shown in FIG. 12).

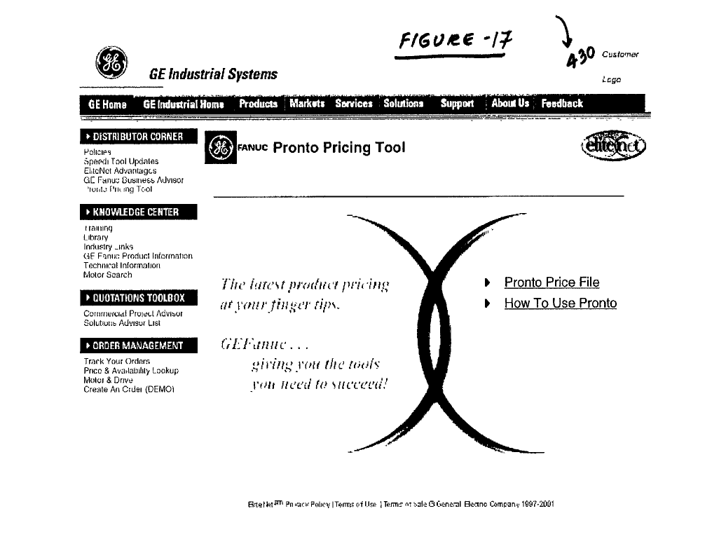

FIG. 17 is an exemplary embodiment of a Pronto Pricing Tool user interface 430 downloaded and displayed by server system 12 when the user selects Pronto Pricing Tool 344 hypertext link (shown in FIG. 12).

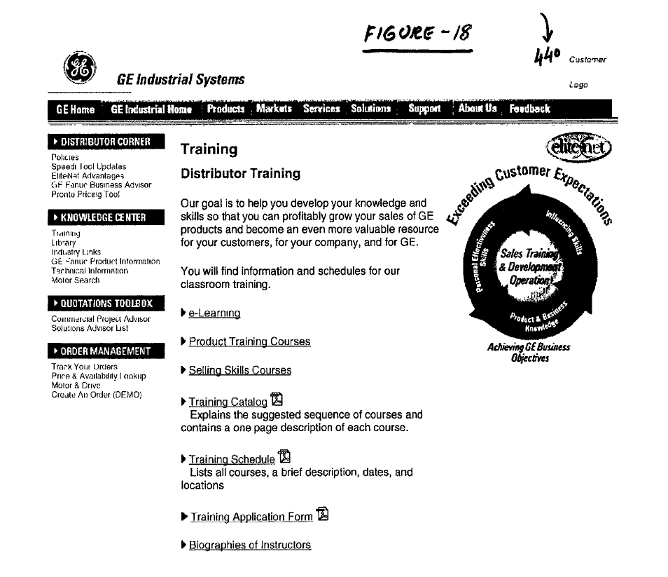

FIG. 18 is an exemplary embodiment of a Training user interface 440 downloaded and displayed by server system 12 when the user selects Training 348 hypertext link (shown in FIG. 12).

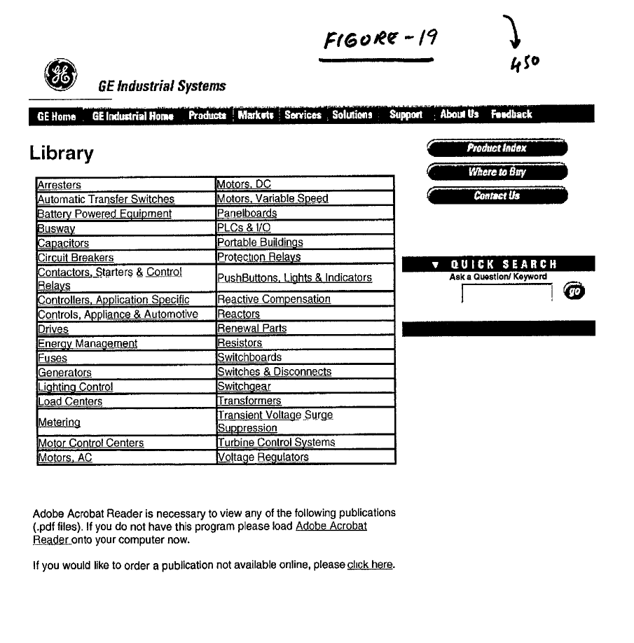

FIG. 19 is an exemplary embodiment of a Library user interface 450 downloaded and displayed by server system 12 when the user selects Library 350 hypertext link (shown in FIG. 12).

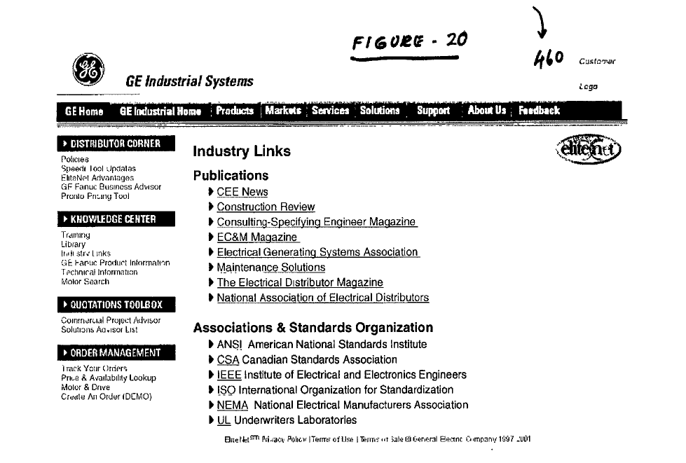

FIG. 20 is an exemplary embodiment of an Industry Links user interface 460 downloaded and displayed by server system 12 when the user selects Industry 352 hypertext link (shown in FIG. 12).

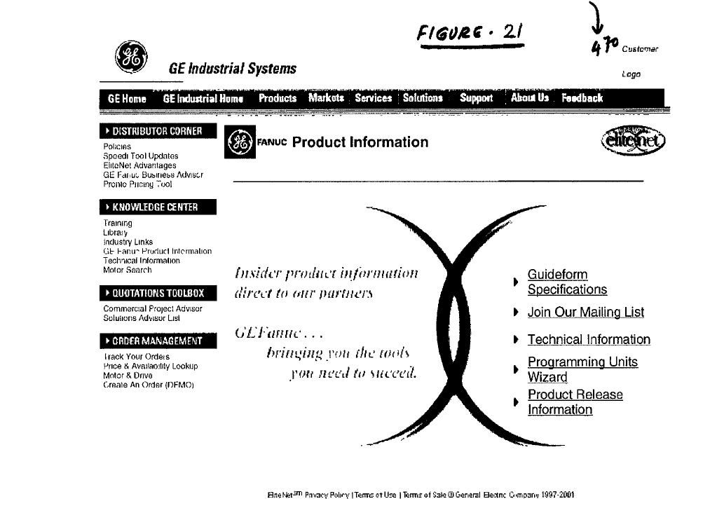

FIG. 21 is an exemplary embodiment of a Product Information user interface 470 downloaded and displayed by server system 12 when the user selects Product Information 354 hypertext link (shown in FIG. 12).

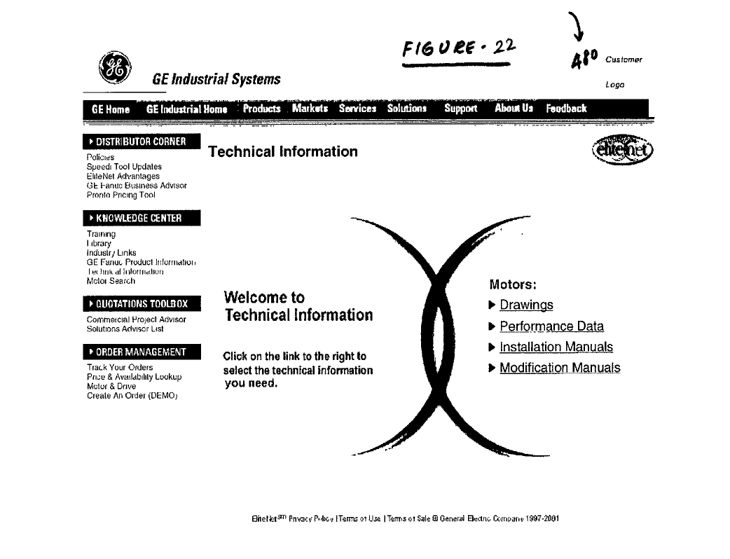

FIG. 22 is an exemplary embodiment of a Technical Information user 480 downloaded and displayed by server system 12 when the user selects Information 356 hypertext link (shown in FIG. 12).

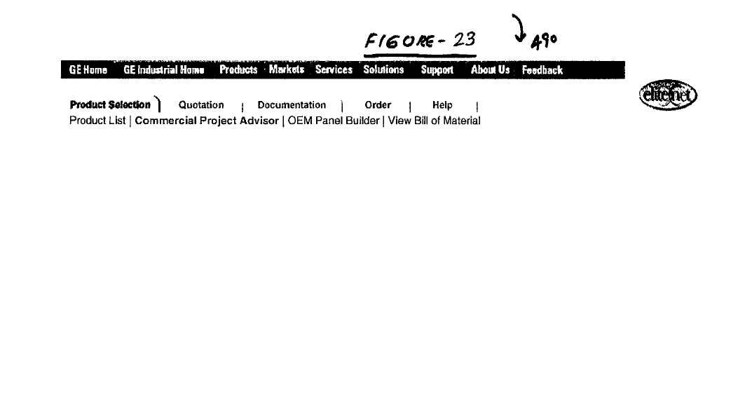

FIG. 23 is an exemplary embodiment of a Motor Search user interface 490 downloaded and displayed by server system 12 when the user selects Motor Search 358 hypertext link (shown in FIG. 12).

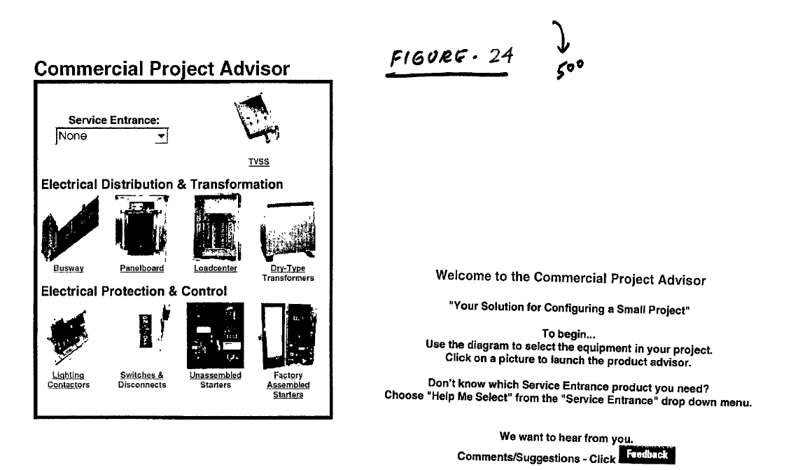

FIG. 24 is an exemplary embodiment of a Commercial Project Advisor user interface 500 downloaded and displayed by server system 12 when the user selects Commercial Project Advisor 362 hypertext link (shown in FIG. 12).

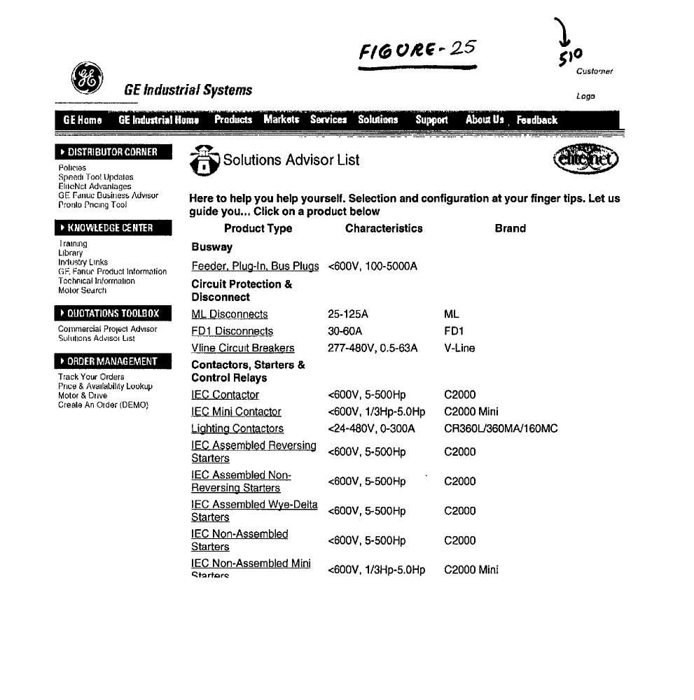

FIG. 25 is an exemplary embodiment of a Solutions Advisor List user 510 downloaded and displayed by server system 12 when the user selects Advisor List 364 hypertext link (shown in FIG. 12). Solutions Advisor List user interface 510 helps to identify selection and configuration of various products by utilizing a product selection and pricing wizard.

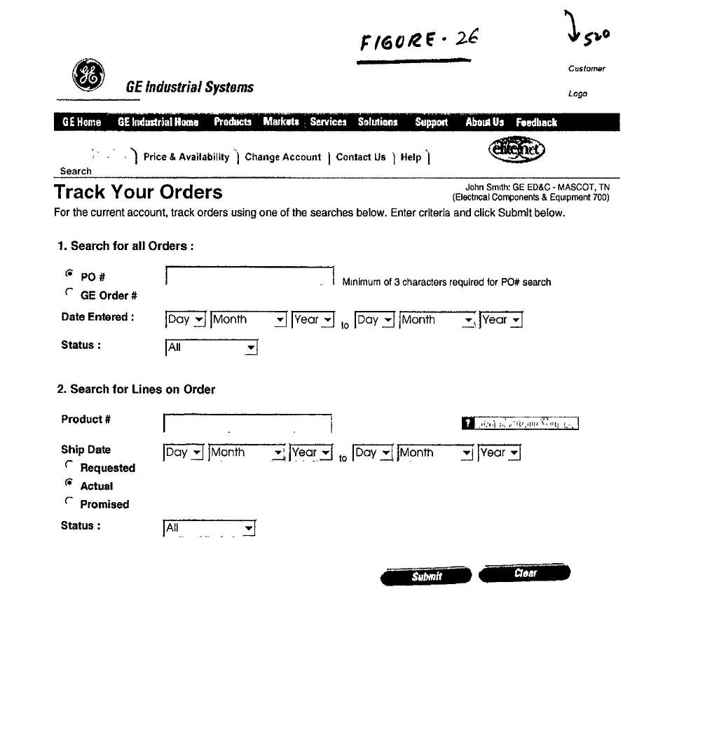

FIG. 26 is an exemplary embodiment of a Track Your Orders user interface 520 downloaded and displayed by server system 12 when the user selects Track Your Orders 368 hypertext link (shown in FIG. 12). Track Your Orders user interface 520 helps the user to track a specific order using one of the pre-selected searches based on a purchase order number, a corporation order number, a number, a description, etc.

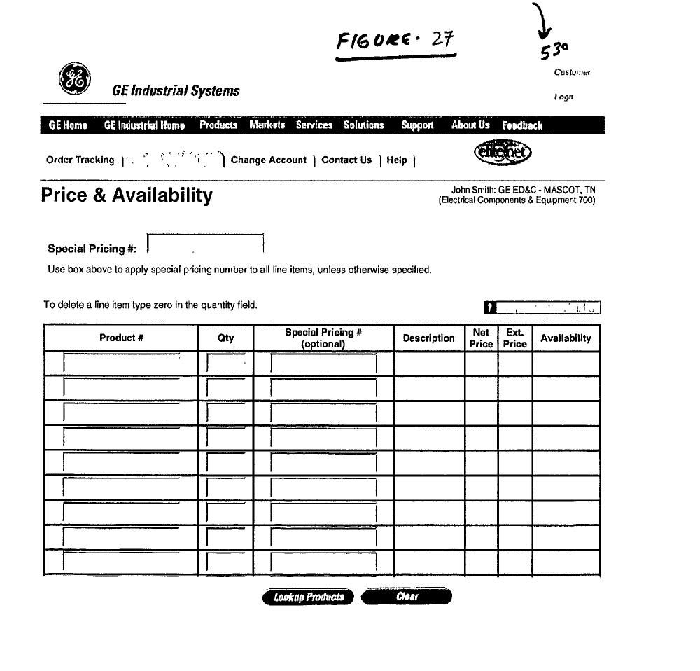

FIG. 27 is an exemplary embodiment of a Price & Availability Lookup user interface 530 downloaded and displayed by server system 12 when the user selects Price & Availability Lookup 370 hypertext link (shown in FIG. 12).

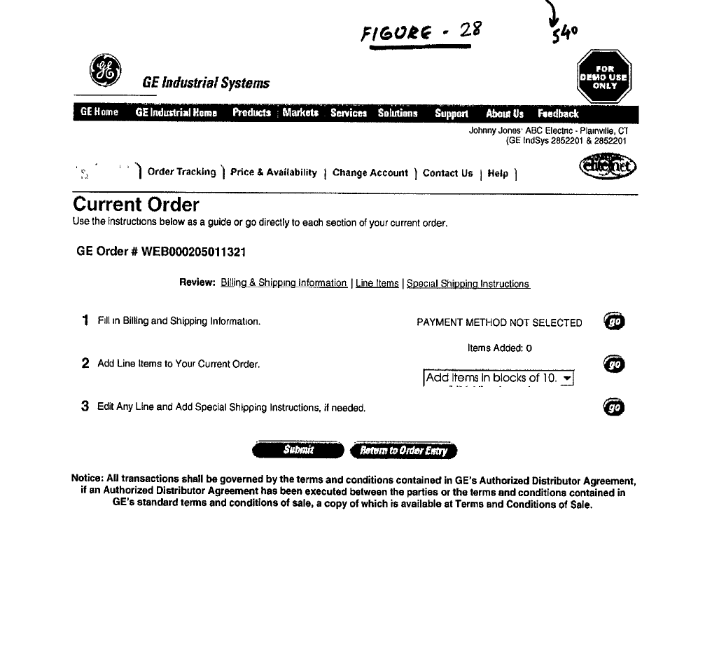

FIG. 28 is an exemplary embodiment of a Current Order user interface 540 downloaded and displayed by server system 12 to help the user obtaining the information on the current open orders.

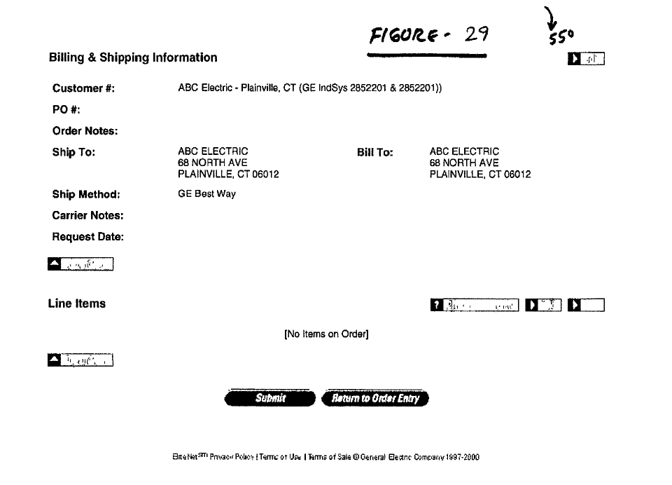

FIG. 29 is an exemplary embodiment of a Billing & Shipping Information user interface 550 downloaded and displayed by server system 12 to help facilitate the user obtaining the billing and shipping information on open orders.

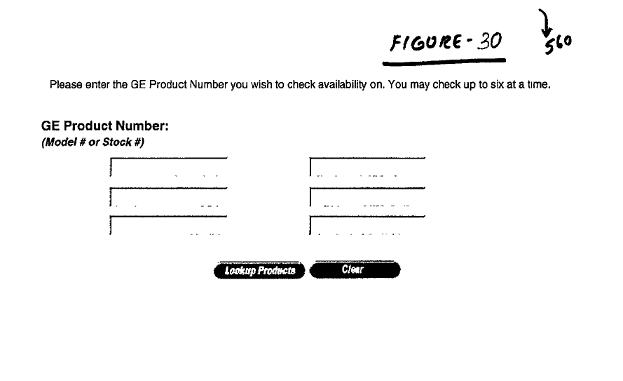

FIG. 30 is an exemplary embodiment of an Availability user interface 560 downloaded and displayed by server system 12 to help obtain product availability information based on model number or a stock number.

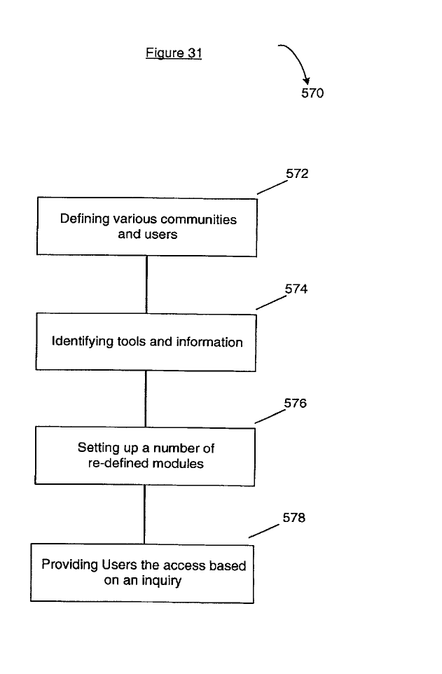

FIG. 31 is an exemplary embodiment of a flow chart 570 describing the method for organizing communities of users having similar needs and interests. method utilizes a web-based system including a server system coupled to a centralized interactive database and at least one client system. The method the steps of defining various communities and users of various communities 572, identifying tools and information relating to various communities 574, setting up a number of pre-defined modules for each community 576 and providing users to a specific community and associated modules of the specific community 578 based on enrollment criteria to obtain information stored in a centralized database in response to an inquiry. The method further includes organizing various communities into various sub-sections of the database.

In one embodiment, client system 14, as well as server system 12, are from access by unauthorized individuals. As described, CCS 10 includes an interactive searchable database 20 for customers and communities related information. Through CCS 10, managers, sales representatives (including contractors and variable workers) and database administrators directly update, review and generate reports of current information.

While the invention has been described in terms of various specific embodiments, those skilled in the art will recognize that the invention can be practiced with modification within the spirit and scope of the claims.

1. A method for organizing communities of users having similar needs and interests using a web-based system including a server system coupled to a centralized interactive database and at least one client system, said method comprising the steps of:
defining various communities and users of various communities;
identifying tools and information relating to various communities;
setting up a number of pre-defined modules for each community; and
providing users access to a specific community and associated modules of specific community based on enrollment criteria to obtain information stored in a centralized database in response to an inquiry.

2. A method according to claim 1 wherein said step of defining various communities further comprises the step of organizing various communities into various sub-sections of the database.

3. A method according to claim 1 wherein said step of defining various communities further comprises the step of defining various communities categories including at least one of a Distributor Communities category, an Original Equipment Manufacturers (OEM) Communities category, an Utility Communities category, an Industrial Communities category, and a Communities category.

4. A method according to claim 3 wherein said step of defining a Distributor Communities category further includes defining at least one of a sub-of Electrical Wholesalers, Process and Automation Distributors, Motor Distributors, Utility Distributors and Asian Distributors.

5. A method according to claim 3 wherein said step of defining an OEM Communities category further includes defining at least one of a sub-of CM & C OEMs, Systems OEMs, Facility OEMs, Machine tool OEMs, and a PMCS Integrator Network.

6. A method according to claim 3 wherein said step of defining an Utility Communities category further includes defining at least one of a sub-of Investor Owned Utilities.

7. A method according to claim 3 wherein said step of defining an Industrial Communities category further includes defining at least one of a sub-for Intel, Paper Industry, and Metal Industry.

8. A method according to claim 3 wherein said step of defining a Contractor Communities category further includes defining at least one of a sub-for Mr. Electric.

9. A method according to claim 1 wherein said step of identifying tools and information relating to various communities further comprises the steps of:
identifying information important and necessary to various communities; and
storing the information in the centralized database in to various sub-section of the database.

10. A method according to claim 1 wherein said step of setting up a number of pre-defined modules for each community further comprises the step of setting up a number of pre-defined modules for at least one of a Distributor Communities category, an Original Equipment Manufacturers (OEM) Communities category, an Utility Communities category, an Industrial Communities category, and a Contractor Communities category.

11. A method according to claim 10 wherein said step of setting up a number of pre-defined modules for a Distributor Communities category further comprises the step of setting up at least one of a Distributor Corner Module, Knowledge Center Module, a Quotations Toolbox Module, and an Order Management Module.

12. A method according to claim 1 wherein said step of providing users access a specific community and associated modules further comprises the step of providing access to the users based on pre-defined roles of the users.

13. A method according to claim 1 wherein said step of providing users access a specific community and associated modules further comprises the step of providing access to the users on pre-defined authentication criteria established by the system“s administrator responsible for managing the access within the specific community.

14. A customer enrollment method managed by an administrator for organizing communities of users having similar needs and interests using a web-based system including a server system coupled to a centralized interactive and at least one client system, said method comprising the steps of:
completing a Location Administrator Enrollment Form; and
completing a User Enrollment Form to set up each individual user in a centralized database with a defined community, role access and other unique identifiers.

15. A method according to claim 14 wherein said step of completing a Location Administrator Enrollment Form further comprises the step of completing the Location Administrator Enrollment Form on-line by an authorized location administrator.

16. A method according to claim 14 wherein said step of completing a Location Administrator Enrollment Form further comprises the step of completing the Location Administrator Enrollment Form by only one location administrator each customer location.

17. A method according to claim 14 wherein said step of completing a Location Administrator Enrollment Form further comprises the step of identifying the customer to specify a specific community out of four possible options.

18. A method according to claim 14 wherein said step of completing a Location Administrator Enrollment Form further comprises the step of providing Location Administration Information including at least one of Location and Account Information, an authorization to use a company logo on the Distributor communities web site, and other pertinent details.

19. A method according to claim 14 wherein said step of completing a Location Administrator Enrollment Form further comprises the step of completing the form by the person who is an employee of the customer and has the responsibility of enrolling and setting up the individual access privileges for the other individuals at the customer location.

20. A method according to claim 14 wherein said step of completing a User Enrollment Form further comprises the step of completing the User Form by a location administrator for each of the approved locations.

21. A method according to claim 20 wherein said step of completing a User Enrollment Form further comprises the step of enrolling individuals by the location administrator.

22. A method according to claim 14 wherein said step of completing a User Enrollment Form further comprises the step of assigning individual roles.

23. A method according to claim 14 wherein said step of completing a User Enrollment Form further comprises the step of providing a Location administrator an additional module in personalized extranet allowing the location administrator to enroll new additional users.

24. A method according to claim 14 wherein said step of completing a User Enrollment Form further comprises the step of completing User Information on-line.

25. A method according to claim 14 wherein said step of completing a User Enrollment Form further comprises the step of identifying user“s role within the business.

26. A method according to claim 14 wherein said step of completing a User Enrollment Form further comprises the step of identifying at least one of default locations of the user, Tools and Services available to the user, and Default Privileges of Order Management.

27. A method according to claim 14 wherein said step of completing a User Enrollment Form further comprises the step of submitting the form for processing by the administrator.

28. A method according to claim 14 wherein said step of completing further includes the step of submitting information through at least one of pull menus, check boxes, and hypertext links.

29. A method according to claim 14 further comprises the step of retrieving information from the centralized database in response to a specific inquiry the administrator.

30. A method according to claim 29 wherein said step of retrieving information further includes the steps of downloading the information in response to the inquiry.

31. A method according to claim 30 wherein said step of downloading the information in response to the inquiry further comprises the steps of:
accessing the centralized database;
searching the database regarding the specific inquiry;
retrieving information from the database; and
transmitting the retrieved information to the client system for display by the client system.

32. A method according to claim 31 further comprising the step of providing flexibility to the administrator to modify user profiles.

33. A method according to claim 31 further comprising the step of providing online help to the user by downloading a user manual on to a client device.

34. The method according to claim 14 wherein the client system and the server system are connected via a network and wherein the network is one of a area network, a local area network, an intranet and the Internet.

35. A web-based system for managing customers in communities of users similar needs and interests, said system comprising:
a client system comprising a browser;
a data storage device for storing information;
a server system configured to be coupled to said client system and said database, said server system further configured to:
create a directory structure to organize information;
receive information into a centralized database;
store the information into various sub-sections of the centralized database and cross-reference the information against an unique identifier for easy retrieval and update; and
retrieve the information from the centralized database in response to an inquiry to provide requested information to the user.

36. A system according to claim 35 wherein said client system is further configured with:
a displaying component; and
a sending component to send an inquiry to the server system so that the server system can process and download the requested information to the client system.

37. A system according to claim 36 wherein the sending component functions in response to a click of a mouse button.

38. A system according to claim 36 wherein the sending component functions in response to a voice command.

39. A system according to claim 36 wherein said system is further configured to be protected from access by unauthorized individuals.

40. A system according to claim 35 wherein said server system is further configured with:
a collection component for collecting information from users into the centralized database;
a tracking component for tracking information on an on-going basis;
a displaying component for displaying various user interfaces;
a receiving component for receiving an inquiry from the client system regarding at least one of a user interface; and
an accessing component for accessing the centralized database and causing the retrieved information to be displayed on the client system.

41. A system according to claim 40 wherein said server system further with a receiving component for receiving an inquiry to provide information from one of a plurality of users.

42. A system according to claim 41 wherein said server system further with a processing component for searching and processing received inquiries against the data storage device containing a variety of information collected by the collection component.

43. A system according to claim 42 wherein said server system further with a retrieving component to retrieve information from the data storage device.

44. A system according to claim 43 wherein said server system further with an information fulfillment component that downloads the requested information after retrieving from the data storage device to the plurality of users in the order in which the requests were received by the receiving component.

45. A system according to claim 35 wherein said server system further to enter information at least through one of a voice activation command and device connected to the client system.

46. A system according to claim 35 wherein said server system further to store the information against an identifier.

47. A system according to claim 35 wherein said server system further to:
track the information on a real time basis; and
store the information on a real time basis by updating stored information by adding the new information to the centralized database on a real time basis provide up-to-date information instantaneously to the user upon a request.

48. A system according to claim 35 wherein said server system further to:
download requested information from a server system; and
display requested information on a client system in response to the inquiry.

49. A system according to claim 48 wherein said server system further to print the requested information in a pre-determined format.

50. A system according to claim 35 wherein said server system further to accept an inquiry from a user.

51. A computer program embodied on a computer readable medium for various customer communities for a corporation, comprising a code segment that sets up a directory structure to organize information into a centralized database and provides users access to a specific community and associated modules of the specific community based on enrollment criteria to obtain information stored in the centralized database in response to an inquiry.

52. The computer program as recited in claim 51 further includes a code that:
defines various communities and users of various communities through an enrollment process;
sets-up a number of pre-defined modules for each community;
identifies the information relating to various communities;
accumulates the information into the centralized database; and
maintains the database by adding, deleting and updating information.

53. The computer program as recited in claim 51 further includes a code that generates management reports.

54. The computer program as recited in claim 51 further includes a code that provides flexibility to an administrator to modify user profile

55. The computer program as recited in claim 51 further includes a code that provides online help to the user by downloading a user manual on to a client device.

56. The computer program as recited in claim 51 further includes a code that organizes information within the centralized database under at least one of a community name, a segment name, a module name, a common module, and a common segment based on pre-defined rules and the directory structure.

57. A computer program embodied on a computer readable medium for customer communities, said computer program capable to be processed by a server system coupled to a centralized interactive database and at least one client system, comprising:
a code segment that receives information;
a code segment that enters the information into a centralized database;
a code segment that stores the information into the centralized database and cross-reference the information against unique identifiers; and
a code segment that provides the information in response to an inquiry.

58. The computer program as recited in claim 57 wherein the network is a wide area network operable using a protocol including at least one of TCP/IP and IPX.

59. The computer program as recited in claim 57 wherein the information is received from the user via a graphical user interface.

60. The computer program as recited in claim 57 further includes a code that provides the information based on access levels.

61. The computer program as recited in claim 57 further includes a code that monitors interaction between various customers within each community.

62. The computer program as recited in claim 57 includes a code segment that displays information through an HTML document downloaded by the server system.

63. The computer program as recited in claim 57 further comprising:
a code segment that accesses the centralized database;
a code segment that searches the database regarding the specific inquiry;
a code segment that retrieves information from the database; and
a code segment that causes the retrieved information to be displayed on the client system.

64. The computer program as recited in claim 57 wherein the client system and the server system are connected via a network and wherein the network is of a wide area network, a local area network, an intranet and the Internet.

65. The computer program as recited in claim 57, and further comprising a code segment that monitors the security of the system by restricting access to unauthorized individuals.

66. A database comprising:
data corresponding to at least one of a Distributor Communities Section, an Original Equipment Manufacturers (OEM) Communities Section, a Utility Communities Section, an Industrial Communities Section, and a Contractor Communities Section;
data corresponding to customers and cross referencing the customers data against unique identifiers;
data corresponding to users and cross referencing the users data against unique identifiers; and
data corresponding to various products and services of a corporation.

67. A database according to claim 66 further comprising data corresponding to sub-sections of at least one of a Distributor Communities Section, an Equipment Manufacturers (OEM) Communities Section, a Utility Communities Section, an Industrial Communities Section, and a Contractor Communities Section.

68. A database according to claim 66 further comprising data corresponding to customers preferences for products and services.

69. A database according to claim 66 further comprising data corresponding to users preferences for payment processing methods.

70. A database according to claim 66 further comprising data corresponding to negative history of customers.

71. A database according to claim 66 wherein said database further configured be protected from access by unauthorized individuals.
